(19) United States
(12) Patent Application Publication
(10) Pub. No.: US 2019/0387368 A1
(43) Pub. Date: Dec. 19, 2019

(54) COMMUNICATION DEVICE PROVIDING HALF-DUPLEX AND PSEUDO FULL-DUPLEX OPERATION USING PUSH-TO-TALK SWITCH

(71) Applicant: MOTOROLA SOLUTIONS, INC, Chicago, IL (US)

(72) Inventors: DANIEL GROBE SACHS, ELMHURST, IL (US); CHARLES B. HARMKE, HUNTLEY, IL (US)

(21) Appl. No.: 16/008,348

(22) Filed: Jun. 14, 2018

(51) Int. Cl. H04W 4/10; H04W 76/45; H04M 9/08; H04M 1/725; H04L 5/14; H04W 88/02

(52) U.S. Cl. CPC H04W 4/10; H04W 76/45; H04W 88/02; H04M 1/72527; H04L 5/14; H04M 9/082

(57) ABSTRACT

A portable communication device provides a pseudo full-duplex communication mode by unmuting a microphone, enabling acoustic echo cancellation (AEC) and decreasing speaker volume when a push-to-talk (PTT) button is pressed, and by muting the microphone during release of the PTT button.

### BACKGROUND OF THE INVENTION

Public safety communication systems continue to evolve in an effort to provide optimal communication services and features within public safety environments, such as law enforcement, fire rescue, and emergency medical to name a few. Portable radio communication devices, such as land mobile radio (LMR) devices, are often operated in conjunction with a remote speaker microphone (RSM) accessory.

Historically, the LMR radio and RSM accessory have been operated in half-duplex applications (also referred to as simplex), in which only one party at a time can talk, while the other listens as compared to telephony devices in which, both parties can communicate with each other simultaneously. Communication over LMR (half-duplex) operation and communication over telephony (full-duplex) operation have typically required the use of separate devices with separate supporting hardware. However, there is an increasing desire to have communication devices that can support both traditional LMR and broadband telephony. The mix of simplex and duplex operation creates challenges for designers, particularly with regards to the need for loud audio in public safety environments. Today's RSM with front ported microphone and front ported loudspeaker, while well suited for loud noise environments in half-duplex operation, is not particularly well suited to high performance duplex operation due to limited return loss between the front ported microphone and loudspeaker (approximately 3 dB). While this limited return loss is acceptable for simplex operation, it is not acceptable for duplex operation incurring issues with acoustic coupling between the microphone and loudspeaker.

Attempting to locate the microphone elsewhere within the device to improve echo return loss (ERL) in half-duplex operation is problematic in terms of adding complexity, cost, and lacking backward compatibility with existing products. Furthermore, moving the microphone away from the front ported location creates issues with maintaining expected LMR use cases as users expect the microphones to be most sensitive, and receive audio loudest, when talking and listening directly in front of the speaker. Hence, it is highly desirable to maintain a front ported microphone with a front ported speaker.

Accordingly, there is a need for a portable communication device, such as a remote loudspeaker microphone (RSM) accessory, to maintain a front ported microphone and front ported speaker that can operate in simplex and duplex modes of operation with appropriate echo suppression and loudness.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a block diagram of a portable communication device formed and operating in accordance with some embodiments.

FIG. 1B is a block diagram of a portable communication system formed and operating in accordance with some embodiments.

FIG. 2 is a flowchart for a method of providing a pseudo full-duplex mode of operation for a shoulder wearable portable communication device formed and operating in accordance with some embodiments.

FIG. 3 is an example of a portable communication system formed and operating in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Briefly, there is provided herein a single portable communication device that supports both broadband and land mobile radio (LMR) audio communications. The portable communication device is a shoulder wearable device which may be embodied as a stand-alone device, or an accessory, such as a remote speaker microphone. The portable communication device comprises a push-to-talk (PTT) button, speaker, and microphone. The portable communication device is considered a near side device, whose audio will be referred to as near-side audio, which can communicate with another, remote device, referred to as a far side device, whose audio will be referred to as far-side audio. Communication between the near side device and far side device is established via a PTT press. LMR communications take place using a simplex mode of operation, and broadband communications take place using a pseudo-duplex mode of operation. Changeover from broadband connectivity to LMR connectivity may occur seamlessly when a broadband connection is lost. Both broadband audio communication and LMR audio communication are advantageously controllable via the PTT of the single portable communication device.

During a duplex operation, audio from the far side device which is received and played out by the near side device speaker may be acoustically or mechanically coupled to the near side device's unmuted microphone, which results in the acoustically coupled audio being processed at the near side device and transmitted back to the far-end device which is heard as an echo by the far end user. This echo causes the far end user to “hear himself” which is referred to as a talkback condition. In accordance with the embodiments, there is provided an apparatus and method for advantageously controlling the isolation between the near side speaker and microphone within the portable communication device. The embodiments described herein, manage the acoustic coupling occurring from the near side speaker to the near side microphone to prevent the talkback audio from reaching the far end device. Gain is controlled to control the absolute level of the echo to be sufficiently low so as to allow for further reduction through an acoustic echo canceller. Once processed through the AEC further isolation is provided by switchably preventing, using a switch, any remaining audio signal from reaching the near side device transceiver.

For ease of description, some or all of the exemplary systems presented herein are illustrated with a single exemplar of each of its component parts. Some examples may not describe or illustrate all components of the systems. Other exemplary embodiments may include more or fewer of each of the illustrated components, may combine some components, or may include additional or alternative components.

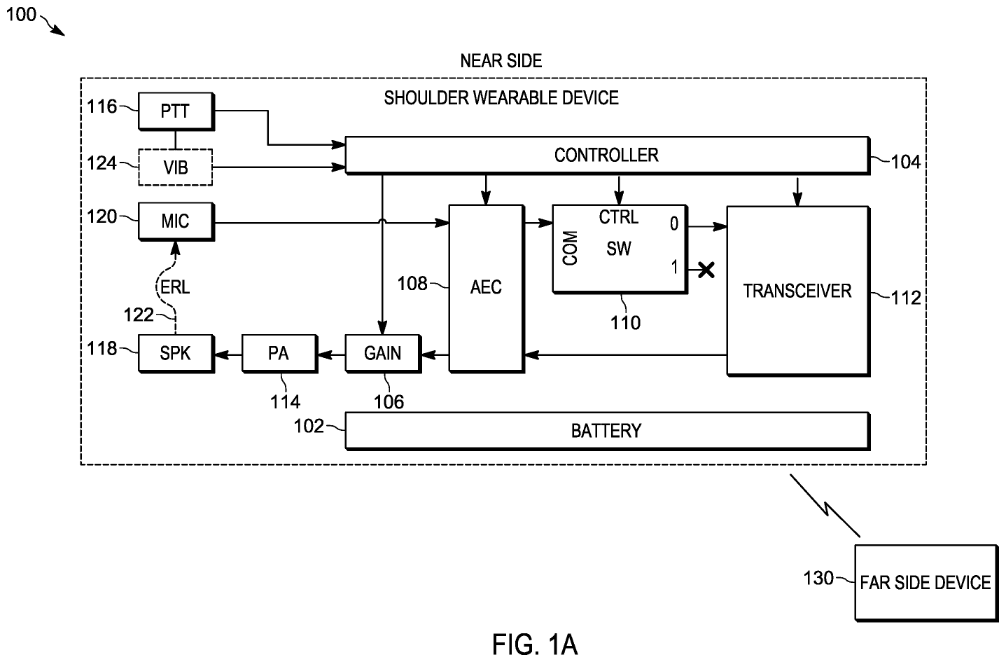

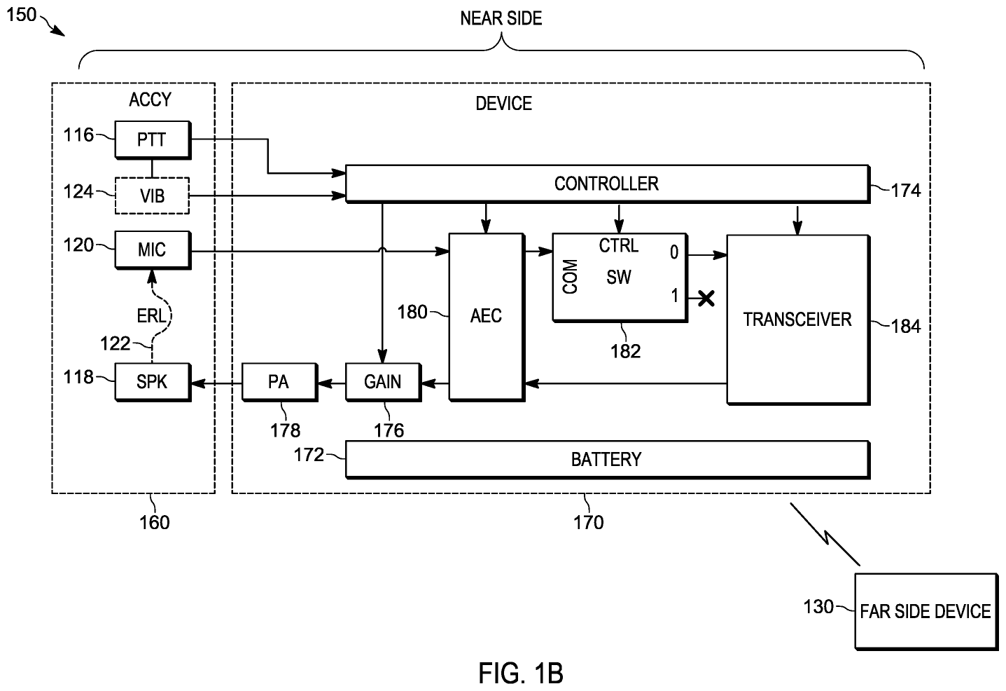

FIG. 1A is a block diagram of a portable communication device 100 formed and operating in accordance with some embodiments. The portable communication device 100 is a shoulder wearable communication device powered by a battery 102 located within the device. The portable communication device 100 operates under the control of a controller 104 located within the portable communication device. The controller 104 controls a plurality of components and stages within device 100, such as a gain stage 106 for setting the gain to an audio power amplifier 114, an automatic echo canceller (AEC) 108, a control switch 110, and a transceiver 112. The portable communication device 100 further comprises a PTT switch 116, a speaker 118, and a microphone 120. The speaker 118 and microphone 120 are ported to a front surface of the portable communication device. The PTT switch 116 will also be referred to as PTT button. The control switch 110 will also be referred to as transmit audio microphone switch.

The front ported speaker and microphone are susceptible to acoustic coupling 122 from the speaker 118 to the microphone 120, shown as echo return loss (ERL). In accordance with the embodiments, isolation between the speaker 118 and microphone 120 is improved during a pseudo-duplex mode of operation. The isolation between the speaker 118 and microphone 120 is represented via an acoustic coupling signal 122 characterized by an echo return loss (ERL). The echo return loss of acoustically coupled signal 122 is a measurable parameter, measurable in decibels (dB). In accordance with the embodiments, echo cancellation is provided within portable communication device 100 to cancel near side audio in order to prevent a far side device 130 (sometimes referred to as a far end device) from receiving talkback, in other words to prevent the far side user from hearing himself in the form of an echo. This echo cancellation is possible only if the echo signal level, which is the received signal level, plus or minus the gain 106, minus the echo return loss, is less than a measurable echo cancellation threshold parameter.

The pseudo full-duplex communication is provided in two modes comprising a first mode of operation in which the PTT 116 is pressed, and a second mode of operation in which the PTT is not pressed.

During the first mode of pseudo fulll-duplex operation, the PTT 116 is pressed, the microphone 120 is unmuted for transmit audio input to the microphone, echo-cancelling by AEC 108 is enabled, and speaker volume is limited to a predetermined volume threshold at which echo cancellation is possible. In other words, the gain at the gain stage 106 is set to ensure that the received signal played at the speaker 118, minus the echo return loss, is less than the echo cancellation threshold parameter. If the near end user hears someone trying to talk, they can ask the far end user to repeat and release the PTT to enable loud audio.

Upon release of the PTT button during pseudo full-duplex operation, the gain stage 106 in the receive speaker path, is ramped to a predetermined level, such as ramped back to 0 dB, the AEC 108 adaptive echo cancellation is frozen by controller 104, and the transmit audio microphone switch 110 is opened thereby disabling the microphone transmit path. This ramping advantageously prevents acoustic shock.

During the second mode of pseudo full-duplex operation in which the PTT 116 is not pressed, the gain stage 106 is set at a maximum level for enabling audio amplification at the audio power amplifier 114 beyond the predetermined volume threshold at which echo cancellation is possible, thereby enabling a loud audio signal to drive the speaker 118. In this second mode, echo-cancellation of the AEC 108 is frozen thereby preventing the AEC from being adversely affected by the audio coupling 122 from the speaker 118 to the microphone 120. In this second mode, the audio coupling 122 is also muted by opening the switch 110 thereby preventing coupled audio 122 from reaching the transceiver 112.

In accordance with a further embodiment, the echo canceller 108 may be re-enabled and the microphone 120 remain muted via switch 110 when a speaker drive level minus echo return loss falls below a predetermined limit for successful echo cancellation. This permits echo canceller adaptation of AEC 108 to continue when loud receive audio is not present, allowing the echo canceller to be effective immediately when PTT button 116 is pressed.

In accordance with some embodiments, the portable communication device 100 also supports LMR half-duplex operation. During LMR half-duplex mode of operation, the microphone 120 is unmuted via switch 110 during both release of the PTT 116 and pressing of the PTT. In LMR half-duplex operation acoustic echo cancellation (AEC) 108 is disabled and speaker volume remains at full volume when the PTT 116 is pressed.

In some embodiments, tactile feedback, such as a vibrator 124, may be provided to the PTT button 116 of the near side device 100 to indicate the presence of double talk (i.e. the near side user is talking into the near side device 100 and the far side user is talking into the far side device 130 at the same time). This raises awareness of the user to incoming audio, aiding in the case where incoming audio is not heard at the reduced volume.

While the battery 102, controller 104, echo canceller 108 and gain stage 106 are shown as being located in the portable communication device 100 in FIG. 1A, other embodiments are possible in which the portable communication device operates as an accessory thereby permitting these components to be located in a portable radio operating in conjunction with the accessory, such as a. remote speaker microphone (RSM). The RSM may be communicatively coupled to a full-duplex PIT over cellular (POC) communication device or a. converged device providing both LMR and broadband. FIG. 1B, shows an example of such an embodiment.

FIG. 1B is a block diagram of a portable communication system 150 formed and operating in accordance with some embodiments comprising an accessory 160 and a portable radio communication device 170. In this embodiment, the components of PTT 116, speaker 118, microphone 120 are located at the accessory 160, which is a shoulder worn accessory, such as a remote speaker microphone (RSM) in which the microphone and speaker are front ported and susceptible to acoustic coupling 122 from the speaker 118 to the microphone 120. The remaining components comprising a battery 172, a controller 174, a gain stage 176, an audio power amplifier 178, an automatic echo canceller (AEC) 180, a control switch 182, and a transceiver 184 are located in the portable communication device 170. Operation is the same as described in FIG. 1A. The RSM 160 may be wired or wirelessly coupled to device 170. Device 170 may be a LMR radio, or a full-duplex PTT over cellular (POC) communication device or a converged LMR and broadband device. The RSM 160 is thus advantageously interchangeable amongst an LMR radio, a full-duplex PTT over cellular (POC) communication device, and a converged LMR and broadband device.

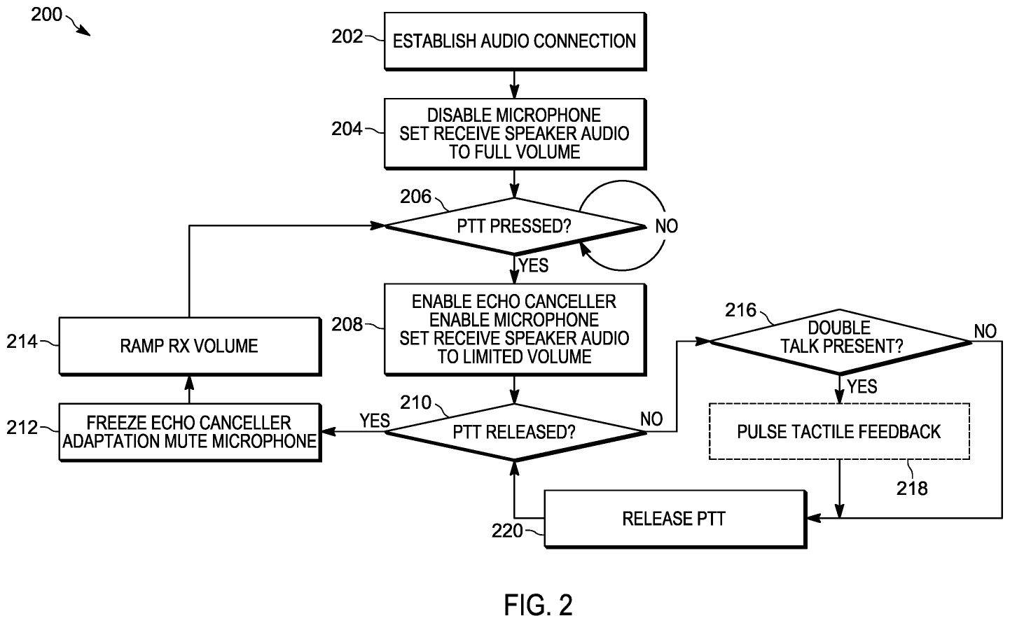

FIG. 2 is a flowchart for a method 200 of providing a pseudo-duplex mode of operation operating in a shoulder wearable communication device formed and operating in accordance with various embodiments. Method 200 will be described in terms of controlling a remote speaker microphone (RSM) attached to a Land Mobile Radio (LMR), wherein the RSM has a front ported microphone and front ported speaker. The method begins by establishing an audio connection with the RSM at 202, muting a microphone of the RSM and setting a speaker of the RSM audio to full volume for loud receive audio at 204. The method continues at 206 by monitoring for a PTT button press. In response to the PTT button being pressed at 206, the method provides for enabling echo cancellation, unmuting the microphone, and setting the speaker audio for limited volume for reduced receive audio at 208. The PTT is monitored for release at 210. The method provides for receiving audio input to the microphone during the PTT press. In response to the PTT button being released, the method provides for freezing echo canceller adaptation and muting the microphone at 212, and further ramping the speaker audio back up to full volume at 214 for loud receive audio.

The method 200 further provides for monitoring for a double talk condition at 216 during the PTT button press of 210. The method may, in some embodiments, provide for generating pulsed tactile feedback 218 at the PTT, in response to the double talk condition being detected 216. This raises awareness of the user to incoming audio, aiding in the case where incoming audio is not heard at the reduced volume. Release of the PTT returns the method to 210 for return through the PTT release path 220.

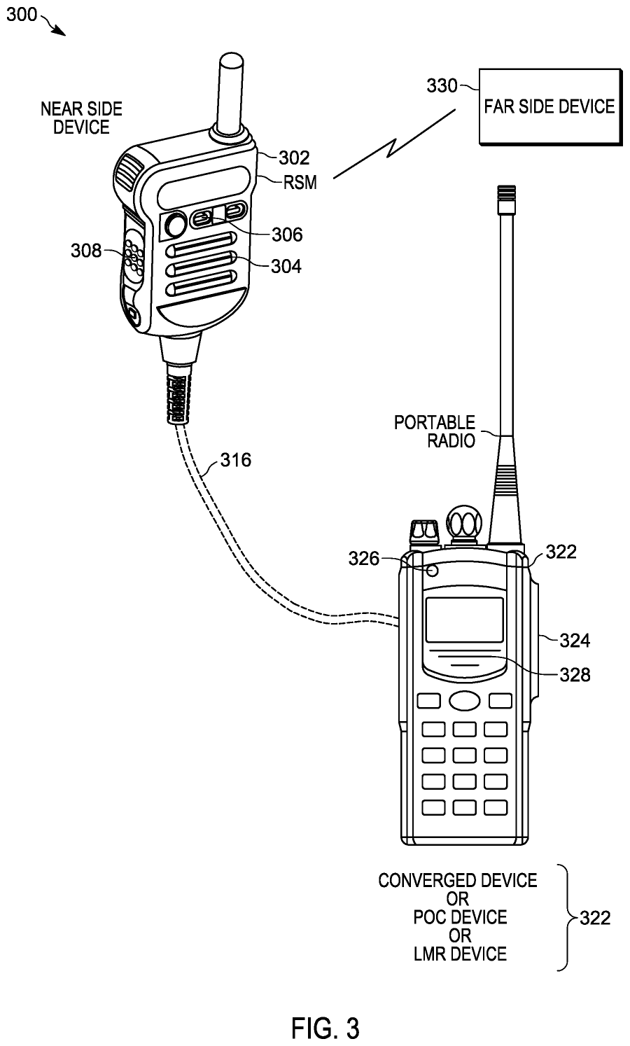

FIG. 3 is a portable communication system 300 comprising a portable accessory 302 operatively coupled to a portable radio device 322 in accordance with various embodiments. The portable communication system 300 is considered a near side system communicating with a far side device 330. The portable accessory 302 may comprise a remote speaker microphone (RSM) having a speaker 304, a microphone 306, and a push-to-talk (PTT) button 308, as well as internal components as previously described in earlier embodiments. The RSM speaker 304 and RSM microphone 306 are proximately located near each other and both are front ported to a front surface of the RSM, and are therefore susceptible to the audio coupling as previously described.

The coupling between the RSM 302 and portable radio 322 may comprise a wired or wireless interface 316, such as a wired cable interconnect or a wireless Bluetooth interconnect. Portable radio device 322 may be a portable land mobile radio (LMR) device, a PTT over cellular (POC) device operating over broadband, or a converged LMR/Broadband device. Although shown with external antennas, it is understood that internal antennas may be used depending on the portable system's type of radio device 322. Portable radio device 322 comprises a PTT 324, a microphone 326, and a speaker 328 as well as radio controller and transceiver. The RSM 302 provides remote PTT, speaker, and microphone functionality as a shoulder wearable accessory to the portable radio device 322. The RSM 302 is advantageously interchangeably operational with any of the portable LMR device, POC device operating over broadband, and converged LMR/Broadband device.

In accordance with this embodiment, the RSM PTT 308 controls a simplex audio communication mode when the RSM 302 is operatively coupled to the LMR radio device, and the RSM PTT 308 controls a pseudo-duplex audio communication mode when the RSM is operatively coupled to the POC device (broadband device). Also, the RSM 302 may be communicatively coupled to a converged device which provides operation in both LMR and broadband. In accordance with the embodiments, the pseudo-duplex audio communication mode is configured to: mute the RSM microphone 306 and provide full speaker volume at speaker 304 when the RSM PTT 308 is not pressed; unmute the microphone 306, limit speaker volume at RSM speaker 304, enable echo cancellation when the RSM PTT 308 is pressed; and freeze echo cancellation, mute the RSM microphone 306, and ramp up the speaker volume of RSM speaker 304 when the PTT button 308 is released.

In accordance, with the embodiments, the speaker volume is set to a first predetermined gain for full speaker volume when the PTT is not pressed, and the speaker volume is set to a second reduced predetermined gain for reduced speaker volume when the PTT button is pressed, and the speaker volume is ramped up to the first predetermined gain when the PTT is released.

In some embodiments, tactile feedback, such as a vibrator, may be provided on the PTT button 308 of the near side device may be used to indicate the presence of double talk (i.e. the near side user is talking into the near side device 302 and the far side user is talking into the far side device 330 at the same time). This raises awareness of the user to incoming audio, aiding in the case where incoming audio is not heard at the reduced volume.

The pseudo duplex approach provided by the various embodiments is preferable over a true full duplex approach in that no additional hardware is required and loudness has been maintained. The pseudo duplex approach is seamless to the user allowing operation in a manner to which they are accustomed. The embodiments advantageously allow for a front-ported microphone and speaker thereby negating any hardware changes. Shoulder wearable communication devices whether standalone devices or accessory devices cannot be operated in both simplex and duplex operation modes. The embodiments advantageously enable current day LMR shoulder wearable devices and accessories to support duplex operation without the use of an earpiece.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A portable communication device, comprising:
a shoulder wearable housing;
a speaker, a microphone, and a push-to-talk (PTT) button coupled to the shoulder wearable housing, the speaker and microphone being proximately located to each other, and the speaker, microphone, and PTT button operating with an audio processing system formed of an acoustic echo canceller (AEC), a gain stage, an audio power amplifier, and a switch to manage audio coupling from the speaker to the microphone;
the portable communication device providing pseudo full-duplex communication in two modes of operation wherein:
a first mode of operation in which the PTT is pressed, wherein the microphone is unmuted for transmit audio input to the microphone by closing the switch, echo-cancelling of the AEC is enabled, and speaker volume of the speaker is limited by the gain stage and audio power amplifier to a predetermined volume threshold at which echo cancellation is possible; and
a second mode of operation in which the PTT is not pressed, wherein the gain stage is set at a maximum level for enabling audio amplification at the audio power amplifier beyond the predetermined volume threshold at which echo cancellation is possible thereby enabling a loud audio signal to drive the speaker, and echo-cancellation of the AEC is frozen thereby preventing the AEC from being adversely affected by the audio coupling from the speaker to the microphone, and the audio coupling is also muted by opening the switch.

2. The portable communication device of claim 1, wherein the portable communication device comprises a remote speaker microphone (RSM).

3. The portable communication device of claim 2, wherein the RSM is communicatively coupled to a full-duplex PTT over cellular (POC) communication device.

4. The portable communication device of claim 3, wherein the communicative coupling is wired.

5. The portable communication device of claim 3, wherein the communicative coupling is wireless.

6. The portable communication device of claim 1, wherein during the first mode of operation in which the PTT button is pressed, the gain stage is set to ensure that a received signal played at the speaker, minus echo return loss, is less than an echo cancellation threshold parameter of the AEC.

7. The portable communication device of claim 1, wherein upon release of the PTT button, the gain stage is ramped to a predetermined level, the echo canceller is disabled, and the switch is opened.

8. The portable communication device of claim 1, wherein the echo canceller is re-enabled and the microphone remains muted via the switch when a speaker drive level minus echo return loss falls below a predetermined limit for successful echo cancellation, thereby providing for fast echo canceller startup on PTT press.

9. The portable communication device of claim 1, wherein tactile feedback on the PTT button is used to indicate double talk is present.

10. The portable communication device of claim 1, wherein the portable communication device is also operational in a land mobile radio (LMR) half-duplex mode of operation, wherein the microphone is unmuted via the switch during both release of the PTT and pressing of the PTT, and acoustic echo cancellation of the AEC is frozen and speaker volume of the speaker remains at full volume when the PTT is pressed.

11. The portable communication device of claim 1, wherein the microphone is a front ported microphone and the speaker is a front ported speaker.

12. A portable accessory, comprising:
a remote speaker microphone (RSM) having a speaker, a microphone, and a push-to-talk (PTT) button, the RSM being interchangeably operational with a portable land mobile radio (LMR) device and a PTT over cellular device operating over broadband; and wherein:
the PTT button controls simplex audio communication mode when the RSM is operatively coupled to the LMR device; and
the PTT button controls a pseudo-duplex audio communication mode when the RSM is operatively coupled to the POC device, the pseudo-duplex audio communication mode being configured to:
mute the microphone and provide full speaker volume when the PTT button is not pressed;
unmute the microphone, limit speaker volume, and enable echo cancellation when the PTT button is pressed; and
freeze echo canceller adaptation, mute the microphone, and ramp up the speaker volume when the PTT button is released.

13. The portable accessory of claim 12, wherein the speaker volume is set to a first predetermined gain for full speaker volume when the PTT button is not pressed, and the speaker volume is set to a second reduced predetermined gain for reduced speaker volume when the PTT button is pressed, and the speaker volume is ramped up to the first predetermined gain when the PTT button is released.

14. The portable accessory of claim 12, wherein the RSM has a front ported microphone and front ported speaker.

15. The portable accessory of claim 12, wherein the echo canceller and gain stage are located in a full-duplex PIT over cellular (POC) communication device.

16. A method of controlling a remote speaker microphone (RSM) comprising:
establishing an audio connection with the RSM;
muting a microphone of the RSM;
setting a speaker of the RSM audio to full volume for loud receive audio;
monitoring for a PTT button press;
detecting a PTT button press;
enabling echo cancellation, unmuting the microphone, and setting the speaker audio for limited volume for reduced receive audio, in response to the PTT button being pressed;
receiving audio input to the microphone during the PTT button press; and
releasing the PTT button, freezing echo canceller adaptation, muting the microphone, and ramping the speaker audio back up to full volume for loud receive audio in response to the PTT button being released.

17. The method of claim 16, further comprising:
monitoring for a double talk condition during the PTT button press; and
generating pulsed tactile feedback at the PTT button, in response to the double talk condition being detected.

18. The method of claim 16, wherein the RSM has a front ported microphone and front ported speaker.

19. A remote speaker microphone (RSM), comprising:
a speaker;
a microphone;
a push-to-talk (PTT) button; and
the RSM establishing a pseudo full-duplex communication mode wherein the microphone is unmuted, acoustic echo cancellation (AEC) is enabled and speaker volume is decreased when the PTT button is pressed, and wherein the microphone is muted during release of the PTT button.

20. The remote speaker microphone (RSM) of claim 19, wherein the RSM is further operational in a land mobile radio (LMR) environment establishing a half-duplex mode of operation wherein the microphone is unmuted during both release of the PTT button and press of the PTT button, and acoustic echo cancellation (AEC) is disabled and speaker volume remains at full volume when the PTT button is pressed.

21. A method of controlling a shoulder wearable communication device, the method comprising:
providing pseudo full-duplex communication at the shoulder wearable communication device in two modes of operation by:
in a first mode of operation:
muting a microphone of the shoulder wearable communication device;
setting a speaker of the shoulder wearable communication device audio to full volume for loud receive audio;
monitoring for a PTT button press;
in a second mode of operation:
detecting the PTT button press;
enabling echo cancellation, unmuting the microphone, and setting the speaker audio for limited volume for reduced receive audio, in response to the PTT button being pressed;
receiving audio input to the microphone during the PTT button press; and
releasing the PTT button, freezing echo canceller adaptation, muting the microphone, and ramping the speaker audio back up to full volume for loud receive audio in response to the PTT button being released.

22. The method of claim 21, wherein the shoulder wearable communication device is a remote speaker microphone (RSM).

23. The method of claim 21, wherein the shoulder wearable communication device is communicatively coupled to a full-duplex PTT over cellular (POC) communication device.

24. The method of claim 23, wherein the communicative coupling is wired.

25. The method of claim 23, wherein the communicative coupling is wireless.

26. The method of claim 21, wherein during the second mode of operation in which the PTT button is pressed, further comprises setting a gain stage to ensure that a received signal played at the speaker, minus echo return loss, is less than an echo cancellation threshold parameter.

27. The portable communication device of claim 21, further comprising:
re-enabling echo cancellation while maintaining the microphone muted when a speaker drive level minus echo return loss falls below a predetermined limit for successful echo cancellation.

28. The method of claim 21, further comprising:
monitoring for a double talk condition during the PTT button press; and
generating pulsed tactile feedback at the PTT button, in response to the double talk condition being detected.

29. The method of claim 21, wherein the microphone is a front ported microphone and the speaker is a front ported speaker.
